(19) United States
(12) Patent Application Publication
(10) Pub. No.: US 2018/0176573 A1
(43) Pub. Date: Jun. 21, 2018

(54) APPARATUS AND METHODS FOR THE ENCODING OF IMAGING DATA USING IMAGING STATISTICS

(71) Applicant: GoPro, Inc., Carlsbad, CA (US)

(72) Inventors: Sumit Chawla, Carlsbad, CA (US); Adeel Abbas, Carlsbad, CA (US); Sandeep Doshi, Carlsbad, CA (US)

(21) Appl. No.: 15/385,383

(22) Filed: Dec. 20, 2016

(51) Int. Cl. H04N 19/137; G06K 9/62; G06K 9/52

(52) U.S. Cl. CPC H04N 19/137; G06K 9/52; G06K 9/6201

(57) ABSTRACT

Methods and apparatus for the encoding of imaging data using pre-stored imaging statistics. Many extant image capture devices, including without limitation, smartphones, handheld video cameras, and other types of image capture devices, typically include, for example, auto-exposure (AE), auto-white balance (AWB) and auto-focus (AF) modules in an image signal processing (ISP) pipeline. These modules within the ISP pipeline generate various imaging statistics which can be repurposed for the encoding process of video data. These imaging statistics can be utilized for a number of encoding processes including, without limitation, adjusting an encoder parameter value for the encoding process, adjustment of the motion estimation search range, insertion of intra-frames within the video data and the determination of whether to use explicit or implicit weighting prediction.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE DISCLOSURE

### Field of the disclosure

The present disclosure relates generally to the encoding of video images and in one exemplary aspect, to methods and apparatus for the utilization of auto-exposure and auto-white-balance modules for the encoding of video images.

### Description of Related Art

Video encoders such as for example, H.264 advanced video coding (AVC) encoders and high efficiency video coding (HEVC) encoders, are capable of calculating various imaging statistics on the fly. As a result of these capabilities, modern day video encoders may compress natively captured image formats into a format that, inter alfa, reduces their transmission size, while maintaining much of their human-perceptible image qualities. In other words, modern day video encoders enable the ability to transmit encoded video content over a large variety of networking technologies and further enable the ability to be received and decoded by numerous computing devices by reducing the size of the natively captured video content.

However, the algorithms utilized by these video encoders are often not well suited for use with portable devices that are otherwise concerned with reducing processing overhead and power consumption. Many of these video encoding algorithms are computationally expensive and accordingly, may be utilized at the expense of power, resulting in for example, a reduction in the battery life associated with battery-powered devices that include these video encoders. As but one example, H.264 AVC and HEVC video encoders support two types of weighted prediction, namely implicit and explicit weighted prediction within their algorithms. Figuring out whether to use implicit or explicit weighted prediction, and in instances in which explicit weighted prediction is utilized, determining the scale and offset parameters for use with these algorithms is a computationally expensive step for these battery-powered devices.

As a result, many extant video encoders for these battery-powered devices choose not to perform weighted prediction within their algorithms. Furthermore, these video encoders are often times not utilized to their full capabilities and hence are not able to, inter alia, optimize the transmission size (while maintaining a relatively high degree of image quality) associated with these encoded/compressed video formats. Accordingly, methods and apparatus are needed for overcoming the deficiencies associated with existing video encoders. Ideally, such methods and apparatus will reduce computation overhead and power consumption, while simultaneously improving upon the transmission size and quality associated with the encoding of captured video data.

### SUMMARY

The present disclosure satisfies the foregoing needs by providing, inter alia, methods and apparatus for the encoding of imaging data using pre-stored imaging statistics.

In a first aspect of the present disclosure, a computerized apparatus for the encoding of image data is disclosed. In one embodiment, the computerized apparatus includes a processing apparatus; and a storage apparatus in data communication with the processing apparatus, the storage apparatus having a non-transitory computer readable medium that includes instructions which are configured to, when executed by the processing apparatus, cause the computerized apparatus to: obtain a first frame of data included within a video segment, the first frame of data including one or more frame portions; obtain image statistics associated with the first frame of data, the image statistics representing imaging parameters within individual frame portions of the first frame of data; obtain values of an encoder parameter associated with the first frame of data, the values of the encoder parameter representing imaging quality parameters within the individual frame portions of the first frame of data; determine variance of the image statistics between the individual frame portions of the first frame of data; and adjust the values of the encoder parameter within individual frame portions of the first frame of data based upon the determined variance of the image statistics between individual frame portions of the first frame of data.

In one variant, the image statistics include weighted sums of one or more color channels.

In another variant, the image statistics include a variance between one or more color channels from collocated individual frame portions from one or more adjacent frames of data.

In yet another variant, the image statistics include a luminance/chrominance value.

In yet another variant, the encoder parameter includes a quantization parameter.

In yet another variant, the storage apparatus having the non-transitory computer readable medium further includes one or more instructions which are configured to, when executed by the processing apparatus, cause the computerized apparatus to: compare the image statistics of the first frame of data to image statistics of a second frame of data included within the video segment, the second frame of data preceding the first frame of data.

In yet another variant, the storage apparatus having the non-transitory computer readable medium further includes one or more instructions which are configured to, when executed by the processing apparatus, cause the computerized apparatus to: determine a change in motion and/or a change in environment from the second frame of data to the first frame of data based upon the determined variance of the plurality of image statistics between the first frame of data and the second frame of data.

In yet another variant, the storage apparatus having the non-transitory computer readable medium further includes one or more instructions which are configured to, when executed by the processing apparatus, cause the computerized apparatus to: adjust a motion estimation search range based upon the determined change in motion and/or the determined change in environment.

In yet another variant, the storage apparatus having the non-transitory computer readable medium further includes one or more instructions which are configured to, when executed by the processing apparatus, cause the computerized apparatus to: insert intra-frame data into the video segment based upon the obtained image statistics.

In yet another variant, the storage apparatus having the non-transitory computer readable medium further includes one or more instructions which are configured to, when executed by the processing apparatus, cause the computerized apparatus to: determine whether to perform implicit weighted prediction or explicit weighted prediction based upon the determined variance of the plurality of image statistics between the first frame of data and the second frame of data.

In a second embodiment, the computerized apparatus includes a network interface, the network interface configured to transmit encoded frames of video data; a video encoder configured to receive one or more frames of video data, the video encoder also configured to provide the encoded frames of video data to the network interface; and an encoder controller, the encoder controller configured to receive a plurality of imaging statistics from one or more modules of an image signal processing (ISP) pipeline. The encoder controller is configured to modify an encoder parameter and provide the modified encoder parameter to the video encoder, the modified encoder parameter being generated at least in part on the received plurality of imaging statistics.

In one variant, the computerized apparatus is further configured to determine variance within the plurality of imaging statistics.

In another variant, the computerized apparatus is further configured to determine a change in the received one or more frames of video data and adjust a motion estimation search range based at least in part on the determined change.

In yet another variant, the encoder controller is further configured to determine whether to use explicit or implicit weighting prediction, the determination of whether to use explicit or implicit weighting prediction being based at least in part on the received plurality of imaging statistics.

In a second aspect of the present disclosure, a computer readable storage apparatus is disclosed. In one embodiment, the storage apparatus includes a non-transitory computer readable medium that includes instructions which are configured to, when executed by a processing apparatus: obtain a first frame of data included within a video segment, the first frame of data including one or more frame portions; obtain image statistics associated with the first frame of data, the image statistics representing imaging parameters within individual frame portions of the first frame of data; obtain values of an encoder parameter associated with the first frame of data, the values of the encoder parameter representing imaging quality parameters within the individual frame portions of the first frame of data; determine variance of the image statistics between the individual frame portions of the first frame of data; and adjust the values of the encoder parameter within individual frame portions of the first frame of data based upon the determined variance of the image statistics between individual frame portions of the first frame of data.

In a third aspect of the present disclosure, an integrated circuit (IC) apparatus is disclosed. In one embodiment, the IC includes logic configured to: obtain a first frame of data included within a video segment, the first frame of data including one or more frame portions; obtain image statistics associated with the first frame of data, the image statistics representing imaging parameters within individual frame portions of the first frame of data; obtain values of an encoder parameter associated with the first frame of data, the values of the encoder parameter representing imaging quality parameters within the individual frame portions of the first frame of data; determine variance of the image statistics between the individual frame portions of the first frame of data; and adjust the values of the encoder parameter within individual frame portions of the first frame of data based upon the determined variance of the image statistics between individual frame portions of the first frame of data.

In a fourth aspect of the present disclosure, a method of encoding imaging data is disclosed. In one embodiment, the method includes: obtaining a first frame of data, the first frame of data including a plurality of frame portions; obtaining a plurality of image statistics associated with the first frame of data, the plurality of image statistics representing imaging parameters within individual frame portions of the first frame of data; determining variance of the plurality of image statistics for the individual frame portions of the first frame of data; and adjusting the values of an encoder parameter within individual frame portions of the first frame of data based upon the determined variance.

In one variant, the method further includes comparing the plurality of image statistics of the first frame of data to image statistics of a second frame of data included within a video segment, the second frame of data preceding the first frame of data.

In another variant, the method further includes determining a change in motion and/or a change in environment from the second frame of data to the first frame of data based upon the determined variance of the plurality of image statistics between the first frame of data and the second frame of data; and adjusting a motion estimation search range based upon the determined change in motion and/or the determined change in environment.

In yet another variant, the method further includes determining whether to perform implicit weighted prediction or explicit weighted prediction based upon the determined variance of the plurality of image statistics between the first frame of data and the second frame of data.

In yet another variant, the method further includes constructing a mapping table, the mapping table configured to map possible image statistic values with explicit weighting prediction parameters.

In yet another variant, the method further includes modifying individual ones of the explicit weighting prediction parameters based at least in part on scene characteristics associated with frames contained within a video segment.

Other features and advantages of the present disclosure will immediately be recognized by persons of ordinary skill in the art with reference to the attached drawings and detailed description of exemplary implementations as given below.

### BRIEF DESCRIPTION OF THE DRAWINGS

FIG. 1 is a logical flow diagram of a generalized method for repurposing obtained image statistics for the encoding of video data, in accordance with the principles of the present disclosure.

FIG. 2 is a logical flow diagram of an exemplary method for adjusting the values of an encoder parameter for use with a video encoder, in accordance with the principles of the present disclosure.

FIG. 3 is a logical flow diagram of an exemplary method for adjusting the motion estimation search range for use with a video encoder, in accordance with the principles of the present disclosure.

FIG. 4 is a logical flow diagram of an exemplary method for inserting an intra-frame into video data for use with a video encoder, in accordance with the principles of the present disclosure.

FIG. 5 is a logical flow diagram of an exemplary method for utilizing a mapping table during explicit weighting prediction for use with a video encoder, in accordance with the principles of the present disclosure.

FIG. 6 is a block diagram of an exemplary implementation of a computerized apparatus, useful in performing the methodologies described herein.

All Figures disclosed herein are © Copyright 2016 GoPro, Inc. All rights reserved.

### DETAILED DESCRIPTION

Implementations of the present technology will now be described in detail with reference to the drawings, which are provided as illustrative examples so as to enable those skilled in the art to practice the technology. Notably, the figures and examples below are not meant to limit the scope of the present disclosure to any single implementation or implementations, but other implementations are possible by way of interchange of, substitution of, or combination with some or all of the described or illustrated elements. Wherever convenient, the same reference numbers will be used throughout the drawings to refer to same or like parts.

Methods and apparatus for the encoding of imaging data using pre-stored imaging statistics are provided herein. Many extant image capture devices, including without limitation, smartphones, handheld video cameras, and other types of image capture devices, typically include, for example, auto-exposure (AE), auto-white balance (AWB) and auto-focus (AF) modules in an image signal processing (ISP) pipeline. While, the AE, AWB, and AF modules in an ISP pipeline are exemplary, it would be appreciated by one of ordinary skill that other modules located within the ISP may also write similar imaging statistics and the principles described herein may be readily adapted to utilize these imaging statistics from these other modules. One purpose of the AE module is to dynamically adjust exposure settings under varying lighting conditions. Moreover, one purpose of the AWB module is to adjust the white balance within the frames of captured video data. These modules are typically designed so as to maintain a harmonious look within their captured video frames such that modification of these exposure settings and white balance settings enable the ability to alter their respective settings over time. Additionally, it should be noted that many of the image capture devices that utilize AE and AWB modules also are configured to minimize abrupt changes to these exposure and white balance settings, thereby improving upon user experience when displaying this obtained video content.

As a brief aside, AE, AF and AWB modules can typically achieve the aforementioned tasks by capturing and storing various image statistics used in these respective ISP algorithms. For example, some AE, AF and/or AWB modules may store and utilize weighted sums of red, green, and blue channels (e.g., luminance) from the raw image captured data. Other AE, AF and/or AWB modules may store and utilize variance information associated with the red, green, and blue channels (e.g., the difference of these weighted sum values within a collocated block between a current frame and one or more adjacent frames). In other words, these modules may measure how much these samples vary (spatially) within a given block of imaging data. Yet other AE and/or AWB modules may utilize and store imaging statistics associated with various luminance-chrominance values (e.g., Y'UV, YUV, YCbCr, YPbPr and the like). Additionally, some implementations of AE and/or AWB modules may utilize and store combinations of the foregoing imaging data, or utilize other forms of these imaging statistics for other purposes. In some other implementations, the AF module may store high frequency statistics of the captured image. However, the acquired imaging data used in, for example, these AE and AWB modules are often discarded once these processing algorithms have been performed. However, this acquired imaging data may be useful for other image processing techniques, including, for example, improving upon the aforementioned video encoding process.

Presently available standard video compression codecs, e.g., H.264 (described in ITU-T H.264 (01/2012) and/or ISO/IEC 14496-10:2012, Information technology—Coding of audio-visual objects—Part 10: Advanced Video Coding, each of the foregoing incorporated herein by reference in its entirety), High Efficiency Video Coding (HEVC), also known as H.265 (described in e.g., ITU-T Study Group 16—Video Coding Experts Group (VCEG)—ITU-T H.265, and/or ISO/IEC JTC 1/SC 29/WG 11 Motion Picture Experts Group (MPEG)—the HEVC standard ISO/IEC 23008-2:2015, each of the foregoing incorporated herein by reference in its entirety), and/or VP9 video codec (described at e.g., http://www.webmproject.org/vp9, each of the foregoing incorporated herein by reference in its entirety), may prove non-optimal for certain types of devices when other factors are taken into consideration, such as processing overhead and power consumption as but examples.

To these ends, various aspects of the present disclosure may repurpose data utilized in other modules of the ISP pipelines that may be already present. More directly, since this data may be repurposed, many of the computationally expensive portions of the video encoding process may be obviated, enhanced and/or limited, while maintaining the end result benefits associated with these algorithms. While the following disclosure is primarily discussed with respect to specific algorithmic architectures associated with specific video encoding techniques; artisans of ordinary skill in the related arts will readily appreciate that the principles described herein may be broadly applied to other types of video encoding algorithms where obtained imaging statistics may otherwise be repurposed.

Exemplary Encoding Methodologies

The processes described herein may be performed by a computerized system having at least one processor and a non-transitory computer-readable storage apparatus having a storage medium. The storage medium may store a number of computer-executable instructions thereon, that when executed by the at least one processor, cause the at least one processor to perform the following methodologies described herein. The various methodologies described herein are useful in, for example, the encoding, storage, transmission and/or reception of this captured video data.

Additionally, the processes described herein (or portions thereof) may be performed by dedicated computerized system logic, including without limitation, application-specific integrated circuits (ASICs), field-programmable gate arrays (FPGAs), and/or other types of integrated circuits or dedicated computerized logic that may be utilized in addition to, or alternatively from, the aforementioned computer-readable storage apparatus.

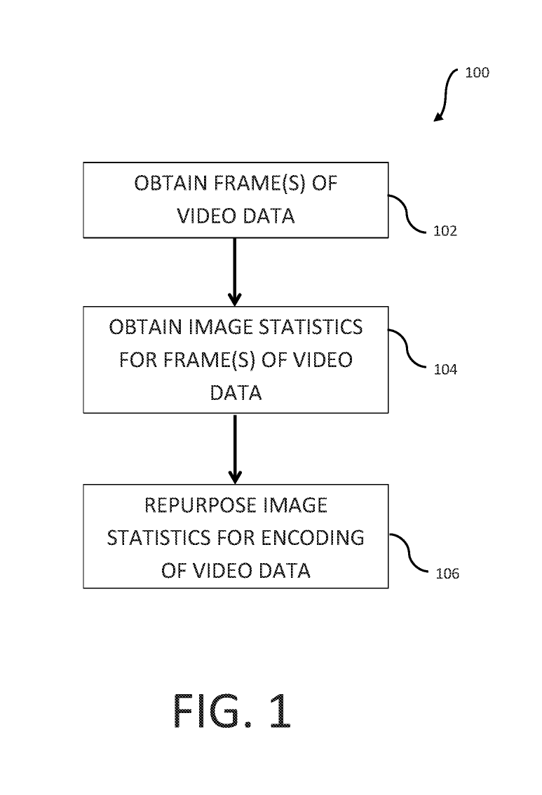

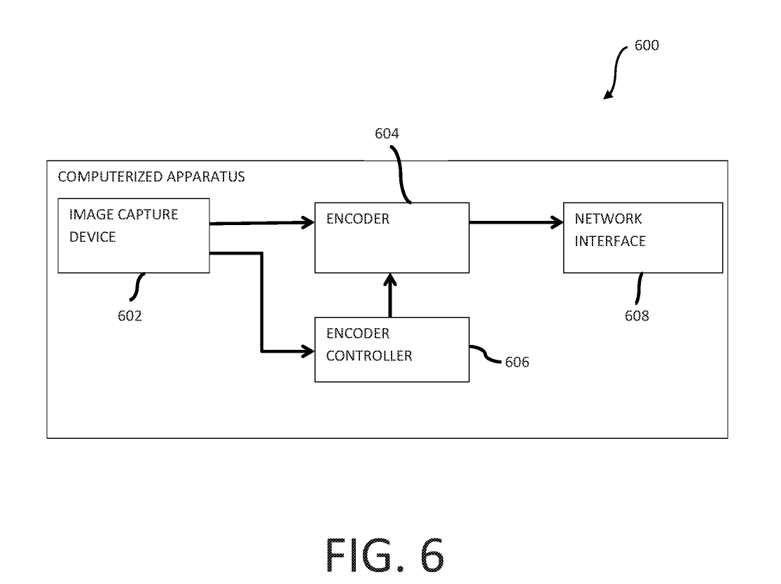

Referring now to FIG. 1, one generalized methodology 100 for the repurposing of previously obtained image statistics is shown and described in detail. At step 102, one or more frames of video data are obtained. These frame(s) of video may be obtained directly from, for example, an ISP device (such as an ISP device contained within the image capture device 602 illustrated in FIG. 6), or in some implementations these obtained frame(s) of video data may be obtained from memory, or some other type of computer readable storage apparatus, subsequent to their capture by an image capturing device.

At step 104, image statistics associated with the aforementioned obtained one or more frames of video data are obtained. For example, these imaging statistics may be repurposed from the aforementioned AE and/or AWB modules, and may take the form of weighted sums of red, green, and blue channels (e.g., luminance) from the raw image captured data. Other forms of imaging statistics may include variance data associated with the red, green, and blue channels (e.g., the difference of these weighted sum values within a collocated block between a current frame and one or more adjacent frames). Yet other imaging statistics may be obtained that are associated with various luminance-chrominance values (e.g., Y'UV, YUV, YCbCr, YPbPr and the like). Additionally, some implementations may utilize and store combinations of the foregoing imaging data, or utilize other forms of these imaging statistics for other purposes.

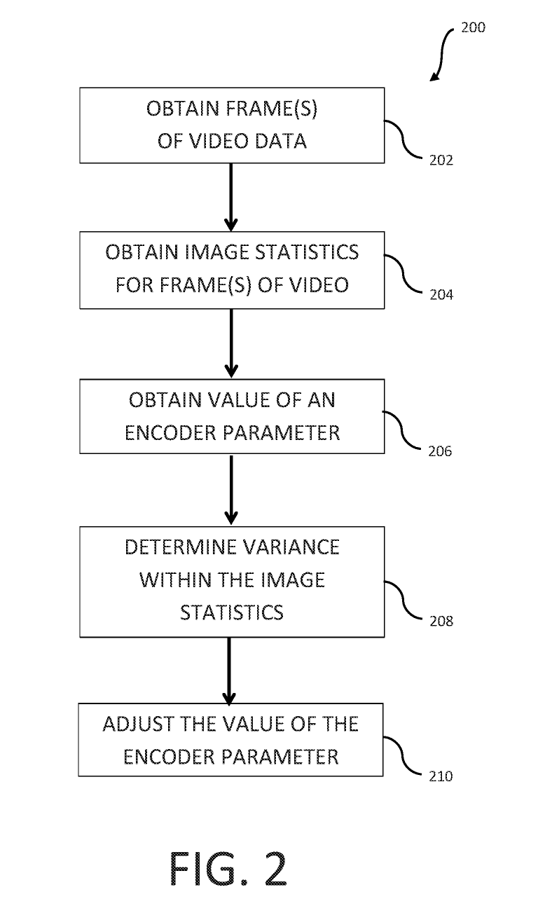

At step 106, these obtained imaging statistics are repurposed for use in the video encoding algorithm. Various repurposing methodologies are described subsequently herein with respect to FIGS. 2-5. Additionally, these obtained imaging statistics may be repurposed for other uses within the video encoding process as would be readily understood by one of ordinary skill given the contents of the present disclosure.

Referring now to FIG. 2, one exemplary methodology 200 for repurposing previously obtained image statistics in the adjustment of the values of an encoder parameter is shown and described in detail. At step 202, one or more frames of video data are obtained. As previously discussed, these frame(s) of video may be obtained directly from, for example, an image capturing device (such as an ISP device contained within the image capture device 602 illustrated in FIG. 6), or in some implementations these obtained frame(s) of video data may be obtained from memory, or some other type of computer readable storage apparatus.

At step 204, image statistics associated with the aforementioned obtained one or more frames of video data are obtained. For example, and as was previously discussed, these imaging statistics may take the form of weighted sums of red, green, and blue channels from the raw image captured data. Other forms of imaging statistics may include variance data associated with the red, green, and blue channels (e.g., the difference of these weighted sum values within a collocated block between a current frame and one or more adjacent frames). Yet other imaging statistics may be obtained that are associated with various luminance-chrominance values (e.g., Y'UV, YUV, YCbCr, YPbPr and the like). Additionally, some implementations may utilize and store combinations of the foregoing imaging data and/or other forms of imaging data available from the ISP pipeline of the underlying device. As a brief aside, a video sequence is composed of a series of frames, with each frame (picture) typically consisting of macroblocks or a coding tree unit (CTU) encoded in raster scan order. As an example, macroblocks in H.264/AVC codec are 16×16 pixels in a frame. HEVC introduced the concept of CTU units, which can be configured at the sequence level, and can assume 64×64, 32×32 or 16×16 pixel dimensions. By way of simple extension, one can readily apply the current methodologies to varying block sizes.

At step 206, an encoder parameter value may be obtained for the video data. In some implementations, this encoder parameter value may be obtained for, for example, each macroblock within the frame of video data. For example, in the context of an H.264 AVC encoder or HEVC encoder, this encoder parameter value may include a quantization parameter (or QP value). As a brief aside, a QP value regulates how much spatial detail is ‘saved’ when encoding a natively captured image into an encoded (compressed) image. In other words, a QP value may correlate to the compression ratio associated with the encoded portion of the image. For example, when a QP value is relatively small, almost all of the imaging detail is retained and hence, the compressed image may be considered to have been compressed less. Alternatively, when a QP value is relatively high, more of the detail from the natively captured image may be lost, resulting in a higher level of compression and hence, a reduced overall image size for this portion of the encoded image. However, when a QP value is increased for a given macroblock, the resultant image within the given macroblock may become distorted and/or the overall image quality associated with that image may be lessened.

At step 208, variance of the image statistics within individual macroblocks within the frame(s) of video data is determined and the associated encoder parameters for these macroblocks may be adjusted using the obtained image statistics at step 210. In one or more implementations, the variance of the image statistics includes inter-frame variance. For example, the variance of the imaging statistics will be determined over a group of two or more frames of imaging data. In one or more other implementations, the variance of the image statistics includes intra-frame variance. For example, the variance of the image statistics will be determined within a single frame of video data.

In the context of adjustment of QP values, human eyes are generally more sensitive to quantization artifacts in flat, low-luminance areas as opposed to high-luminance areas. In other words, in areas within the frame of video data that are considered to have relatively low luminance, the QP values associated with these areas may be decreased, thereby retaining much of the original quality for the natively captured image. Alternatively, in areas within the frame of video data that are considered to have a relatively high luminance, the QP values associated with these areas may be increased (resulting in a reduced transmission bit rate for these areas), while also minimizing the perception of quantization artifacts within the imaging data when displayed to a user. In some implementations, the image statistics may contain information that can help us determine which areas are more sensitive to human eyes (and likewise identify areas that are not sensitive to human eyes). By using this information, an encoder may, for example, lower QP values for blocks of imaging data which are sensitive to our eyesight (e.g., where more detail could be more readily perceived), and increase QP values for blocks of imaging data where our eyes are less sensitive, thereby improving upon the subjective quality of the compressed imaging data, while, for example, maintaining the same operating bitrate.

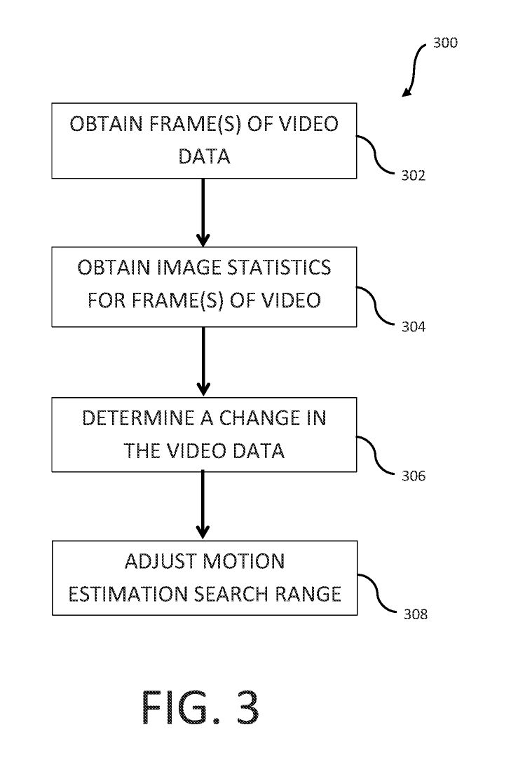

Referring now to FIG. 3, one exemplary methodology 300 for repurposing image statistics in the adjustment of the motion estimation search range is shown and described in detail. As a brief aside, motion estimation (or motion compensation) is an algorithmic technique used to predict, for example, the content contained within a given frame of video data by utilizing previous (or future) video frames. Accordingly, when images contained within a given frame of data can be accurately reproduced using data from nearby frames, the compression efficiency for the video data can be improved.

At step 302, one or more frames of video data are obtained. As previously discussed, these frame(s) of video may be obtained directly from, for example, an image capturing device (such as an ISP device contained within the image capture device 602 illustrated in FIG. 6), or in some implementations these obtained frame(s) of video data may be obtained from memory, or some other type of computer readable storage apparatus.

At step 304, image statistics associated with the aforementioned obtained one or more frames of video data are obtained. For example, and as was previously discussed, these imaging statistics may take the form of weighted sums of red, green, and blue channels from the raw image captured data. Other forms of imaging statistics may include variance data associated with the red, green, and blue channels (e.g., the difference of these weighted sum values within a collocated block between a current frame and one or more adjacent frames). Yet other imaging statistics may be obtained that are associated with various luminance-chrominance values (e.g., Y'UV, YUV, YCbCr, YPbPr and the like). Additionally, some implementations may utilize and store combinations of the foregoing imaging data and/or other forms of imaging data available from the ISP pipeline of the underlying device.

At step 306, a change in the video data is determined by analyzing these obtained image statistics and comparing them to previously captured frames. For example, in some implementations, the determined change may be a change in scene. In some implementations, the change in scene may be detected via characteristic imaging characteristics associated with common film transition techniques such as cut scenes, dissolves, fades, match cuts, wipes and/or other common film techniques in which the content contained within the scene may be expected to change. In other words, these detected changes in scene may be being indicative of the fact that content from a given frame may not be expected to appear in subsequent frames. Additionally, in some implementations, the obtained image statistics may be utilized in order to determine motion of objects contained within the scene. For example, the motion of an object, person, animal, or the motion of the background image may be determined.

At step 308, the motion estimation search range may be adjusted in order to, inter alia, improve upon the compression efficiencies associated with the video encoding process. For example, in some implementations, the determined change in the video data at step 206 may be utilized in order to more accurately predict where portions of a frame of video data may be located within subsequent frame(s) in order to reproduce these portions in these subsequent frame(s) and accordingly, improve the compression efficiency associated with the transmission of this video data. In other implementations, a detected change in scene (such as the aforementioned film transition techniques) may be utilized to conserve processing resources that would otherwise occur when attempting to compress these portions of a video segment. These and other implementations would be readily apparent to one of ordinary skill given the contents of the present disclosure.

In addition to facilitating the adjustment of encoder parameters for a video encoder (FIG. 2), and adjusting the motion estimation search range (FIG. 3), these image statistics captured using, for example, the aforementioned AE and AWB modules may be utilized for other purposes within the video encoding process, such as intra-frame insertion. As a brief aside, Intra-frame insertion (or intra-frame coding) exploits spatial redundancy within a given frame of video data by, inter alia, calculating prediction values through extrapolation from previously coded pixels (and/or macroblocks).

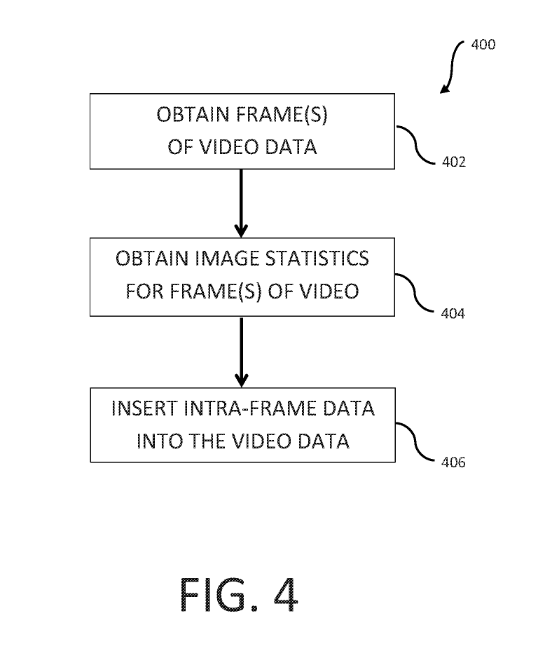

Referring now to FIG. 4, one exemplary methodology 400 for repurposing these various image statistics in the insertion of intra-frames into video data is shown and described in detail. At step 402, one or more frames of video data are obtained. As previously discussed, these frame(s) of video may be obtained directly from, for example, an image capturing device (such as an ISP device contained within the image capture device 602 illustrated in FIG. 6), or in some implementations these obtained frame(s) of video data may be obtained from memory, or some other type of computer readable storage apparatus.

At step 404, image statistics associated with the aforementioned obtained one or more frames of video data are obtained. For example, and as was previously discussed, these imaging statistics may take the form of weighted sums of red, green, and blue channels from the raw image captured data; and/or variance data associated with the red, green, and blue channels (e.g., the difference of these weighted sum values within a collocated block between a current frame and one or more adjacent frames). Yet other imaging statistics may be obtained that are associated with various luminance-chrominance values (e.g., Y'UV, YUV, YCbCr, YPbPr and the like). Additionally, some implementations may utilize and store combinations of the foregoing imaging data and/or other forms of imaging data available from the ISP pipeline of the underlying device.

At step 406, the currently encoded frame is encoded as an intra-frame (rather than inter-frame as it was originally intended). As a brief aside, intra-frame insertion (intra-frame coding) relies on spatially similar information contained within the frames of video data in order to compress otherwise redundant information contained within these frames. In other words, using the knowledge gleaned from the obtained image statistics at step 404, temporal similarity between frames can be roughly calculated. In cases where there is low temporal similarity between frames, inter coding techniques may prove sub-optimal and it may be better to encode the frame as intra-frame. Having these statistics helps us avoid the costly process of performing full intra/inter mode decision for the situations when temporal similarity between frames is low.

For example, consider an instance in which five pixels that are spatially adjacent to one another share the same (or similar) imaging statistics. By utilizing this commonality between this grouping of pixels (as determined from the obtained image statistics at step 404), one may be able to provide information to the video encoder that may enable the video encoder to converge to a better solution more quickly, thereby resulting in fewer clock cycles during the encoding processs and/or lower power consumption utilized for the video encoder.

Additionally, the determination of similarity between groupings of pixels may itself be variable. For example, in the context of luminance/chrominance imaging statistics, the threshold values for determining similarity may vary as a function of the luminance/chrominance values themselves. In other words, luminance/chrominance values associated with lighter areas of the video frame may have larger threshold values (i.e., a larger range of luminance/chrominance values may be determined to be similar), than darker areas of the video frame. Again, by providing this additional knowledge to the encoder (i.e., knowledge gained from the previously obtained imaging statistics at step 404), the encoder may converge to a better solution, while reducing the number of clock cyles for making this determination and/or reducing power consumption.

In addition to the foregoing, in some implementations, the usage of previously generated image statistics may be utilized for performing better weighting prediction (WP) during the video encoding process. As a brief aside, video encoders typically support two types of weighted prediction; namely implicit weighted prediction, and explicit weighted prediction. Implicit weighted prediction generally involves very little bit stream overhead as the parameters utilized in this weighted prediction schema are automatically computed by the decoder based on, for example, the temporal distance between frames in a video segment. In explicit weighted prediction, the prediction block may be scaled and offset with values that are explicitly sent by the video encoder. Furthermore, in case of explicit weighted prediction, these weight and offset parameters can vary within a picture. In prior art implementations, determining whether to utilize implicit weighted prediction or explicit weighted prediction, and in instances in which explicit weighted prediction may be used, determining the scale and offset parameters for this explicit weighted prediction algorithm may be an extremely computationally expensive step. As a result, weighted prediction algorithms are usually not implemented in most encoders. However, when using the aforementioned imaging statistics generated by existing modules (e.g., AE, AF and AWB modules present within modern computing device ISP pipelines), these computationally expensive steps may, for the most part, be obviated.

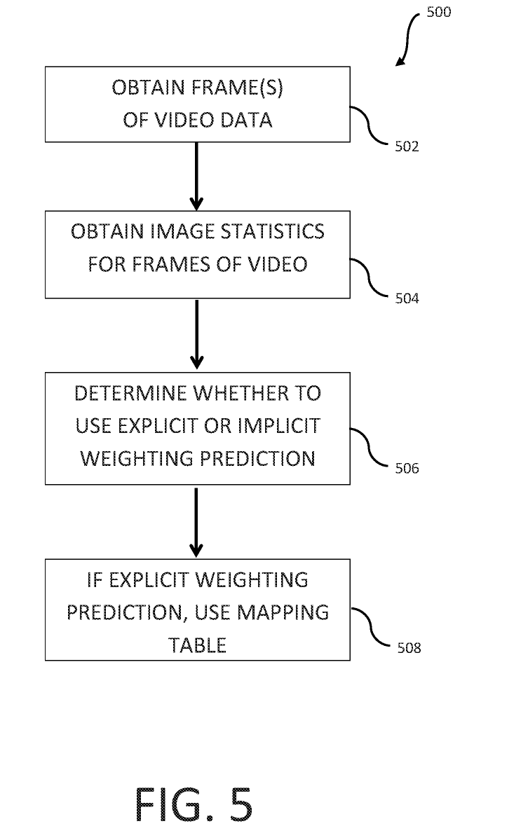

Referring now to FIG. 5, one exemplary methodology 500 for utilizing a mapping table during explicit weighting prediction for use with a video encoder is shown and described in detail. At step 502, one or more frames of video data are obtained. As previously discussed, these frame(s) of video may be obtained directly from, for example, an image capturing device (such as an ISP device contained within the image capture device 602 illustrated in FIG. 6), or in some implementations these obtained frame(s) of video data may be obtained from memory, or some other type of computer readable storage apparatus.

At step 504, image statistics associated with the aforementioned obtained one or more frames of video data are obtained. For example, and as was previously discussed, these imaging statistics may take the form of weighted sums of red, green, and blue channels from the raw image captured data; and/or variance data associated with the red, green, and blue channels (e.g., the difference of these weighted sum values within a collocated block between a current frame and one or more adjacent frames). Yet other imaging statistics may be obtained that are associated with various luminance-chrominance values (e.g., Y'UV, YUV, YCbCr, YPbPr and the like). Additionally, some implementations may utilize and store combinations of the foregoing imaging data and/or other forms of imaging data available from the ISP pipeline of the underlying device.

At step 506, the decision with regards to whether explicit or implicit weighting prediction may be determined. For example, using the aforementioned obtained image statistics, the video encoder may already have the necessary information it needs in order to make this determination, thereby obviating the necessity to perform full mode decision and motion estimation on implicit and explicit modes.

At step 508, if the decision to utilize explicit weighting prediction is made, a weighting table may be implemented so that these explicit weighting parameters may be computed on the fly, thereby avoiding the additional power and speed overhead necessary for performing full mode decision. In one implementation, a mapping table is constructed that maps possible image statistic values of current and previous frames to explicit weighting prediction parameters. This mapping table may be constructed at the time of device manufacture and may be stored in memory (and modified on the fly depending on scene characteristics). Without these statistics, encoders may have to perform costly mode decision that involves trying different explicit weighted prediction parameters and figuring out which of these weighted prediction parameters are best.

Exemplary Apparatus

FIG. 6 is a block diagram illustrating components of an example computerized apparatus 600 useful for performing the aforementioned methodologies described herein. The computerized apparatus 600 may take any number of forms including, without limitation, personal computers (PCs) and minicomputers, whether desktop, laptop, or otherwise, mainframe computers, workstations, servers, personal digital assistants (PDAs), handheld computers (such as handheld image capturing devices), embedded computers, programmable logic devices, personal communicators, tablet computers, portable navigation aids, J2ME equipped devices, cellular telephones, smart phones, personal integrated communication or entertainment devices, or literally any other device capable of executing a set of logical instructions. Moreover, the computerized apparatus may include a computer-readable storage apparatus (not shown) capable of storing and executing a computer program or other executable software.

The computerized apparatus may optionally include an ISP device (located within an image capture device 602). As used herein, the terms “image capture device” and “camera” may be used to refer to any imaging device or sensor configured to capture, record, and/or convey still and/or video imagery, which may be sensitive to visible parts of the electromagnetic spectrum and/or invisible parts of the electromagnetic spectrum (e.g., infrared, ultraviolet), and/or other energy (e.g., pressure waves). The image capture device may be capable of capturing raw imaging data, storing this raw imaging data within memory and/or transmitting this raw imaging data to the encoder 604.

The computerized apparatus may include an encoder 604, such as the aforementioned H.264 AVC encoder, HEVC encoder and/or other types of image and video encoders, which are capable of taking raw imaging data and outputting compressed (encoded) imaging data. The computerized apparatus may also include an encoder controller 606 which may receive as input, the aforementioned image statistics obtained by, for example, extant AE and AWB modules (not shown) present within, for example, the ISP pipeline of the computerized apparatus 600. The encoder controller 606 may also include an output to the encoder 604 such as, for example, an output for the adjusted QP value mentioned above, with regard to FIG. 2).

The computerized apparatus may further include a network interface 608 which is capable of transmitting the encoded/compressed image data to one or more other computing devices that are capable of storing and/or decoding the aforementioned encoded/compressed imaging content.

Where certain elements of these implementations can be partially or fully implemented using known components, only those portions of such known components that are necessary for an understanding of the present disclosure are described, and detailed descriptions of other portions of such known components are omitted so as not to obscure the disclosure.

In the present specification, an implementation showing a singular component should not be considered limiting; rather, the disclosure is intended to encompass other implementations including a plurality of the same component, and vice-versa, unless explicitly stated otherwise herein.

Further, the present disclosure encompasses present and future known equivalents to the components referred to herein by way of illustration.

As used herein, the term “computer program” or “software” is meant to include any sequence or human or machine cognizable steps which perform a function. Such program may be rendered in virtually any programming language or environment including, for example, C/C++, C#, Fortran, COBOL, MATLAB™, PASCAL, Python, assembly language, markup languages (e.g., HTML, SGML, XML, VoXML), and the like, as well as object-oriented environments such as the Common Object Request Broker Architecture (CORBA), Java™ (including J2ME, Java Beans), Binary Runtime Environment (e.g., BREW), and the like.

As used herein, the terms “integrated circuit”, and “IC” are meant to refer to an electronic circuit manufactured by the patterned diffusion of trace elements into the surface of a thin substrate of semiconductor material. By way of non-limiting example, integrated circuits may include field programmable gate arrays (e.g., FPGAs), a programmable logic device (PLD), reconfigurable computer fabrics (RCFs), systems on a chip (SoC), application-specific integrated circuits (ASICs), and/or other types of integrated circuits.

As used herein, the term “memory” includes any type of integrated circuit or other storage device adapted for storing digital data including, without limitation, ROM. PROM, EEPROM, DRAM, Mobile DRAM, SDRAM, DDR/2 SDRAM, EDO/FPMS, RLDRAM, SRAM, “flash” memory (e.g., NAND/NOR), memristor memory, and PSRAM.

As used herein, the term “processor” is meant generally to include digital processing devices. By way of non-limiting example, digital processing devices may include one or more of digital signal processors (DSPs), reduced instruction set computers (RISC), general-purpose (CISC) processors, microprocessors, gate arrays (e.g., field programmable gate arrays (FPGAs)), PLDs, reconfigurable computer fabrics (RCFs), array processors, secure microprocessors, application-specific integrated circuits (ASICs), and/or other digital processing devices. Such digital processors may be contained on a single unitary IC die, or distributed across multiple components.

As used herein, the term “network interface” refers to any signal, data, or software interface with a component, network or process including, without limitation, those of the Firewire (e.g., FW400, FW800, etc.), USB (e.g., USB2), Ethernet (e.g., 10/100, 10/100/1000 (Gigabit Ethernet), 10-Gig-E, etc.), MoCA, Serial ATA (e.g., SATA, e-SATA, SATAII), Ultra-ATA/DMA, Coaxsys (e.g., TVnet.™), radio frequency tuner (e.g., in-band or 00B, cable modem, etc.), Wi-Fi (802.11a,b,g,n), WiMAX (802.16), PAN (802.15), or IrDA families.

As used herein, the term “Wi-Fi” includes one or more of IEEE-Std. 802.11, variants of IEEE-Std. 802.11, standards related to IEEE-Std. 802.11 (e.g., 802.11 a/b/g/n/s/v), and/or other wireless standards.

As used herein, the term “wireless” means any wireless signal, data, communication, and/or other wireless interface. By way of non-limiting example, a wireless interface may include one or more of Wi-Fi, Bluetooth, 3G (3GPP/3GPP2), HSDPA/HSUPA, TDMA, CDMA (e.g., IS-95A, WCDMA, and/or other wireless technology), FHSS, DSSS, GSM, PAN/802.15, WiMAX (802.16), 802.20, narrowband/FDMA, OFDM, PCS/DCS, LTE/LTE-A/TD-LTE, analog cellular, CDPD, satellite systems, millimeter wave or microwave systems, acoustic, infrared (i.e., IrDA), and/or other wireless interfaces.

It will be recognized that while certain aspects of the technology are described in terms of a specific sequence of steps of a method, these descriptions are only illustrative of the broader methods of the disclosure, and may be modified as required by the particular application. Certain steps may be rendered unnecessary or optional under certain circumstances. Additionally, certain steps or functionality may be added to the disclosed implementations, or the order of performance of two or more steps permuted. All such variations are considered to be encompassed within the disclosure disclosed and claimed herein.

While the above detailed description has shown, described, and pointed out novel features of the disclosure as applied to various implementations, it will be understood that various omissions, substitutions, and changes in the form and details of the device or process illustrated may be made by those skilled in the art without departing from the disclosure. The foregoing description is of the best mode presently contemplated of carrying out the principles of the disclosure. This description is in no way meant to be limiting, but rather should be taken as illustrative of the general principles of the technology. The scope of the disclosure should be determined with reference to the claims.

What is claimed:

1. A computerized apparatus for the encoding of imaging data, the computerized apparatus comprising:
a processing apparatus; and
a storage apparatus in data communication with the processing apparatus, the storage apparatus having a non-transitory computer readable medium comprising instructions which are configured to, when executed by the processing apparatus, cause the computerized apparatus to:
obtain a first frame of data included within a video segment, the first frame of data including one or more frame portions;
obtain a plurality of image statistics associated with the first frame of data, the plurality of image statistics representing imaging parameters within individual frame portions of the first frame of data;
obtain values of an encoder parameter associated with the first frame of data, the values of the encoder parameter representing imaging quality parameters within the individual frame portions of the first frame of data;
determine variance of the plurality of image statistics between the individual frame portions of the first frame of data; and
adjust the values of the encoder parameter within individual frame portions of the first frame of data based upon the determined variance of the plurality of image statistics between individual frame portions of the first frame of data.

2. The computerized apparatus of claim 1, wherein the plurality of image statistics comprise weighted sums of one or more color channels.

3. The computerized apparatus of claim 1, wherein the plurality of image statistics comprise a variance between one or more color channels from collocated individual frame portions from one or more adjacent frames of data.

4. The computerized apparatus of claim 1, wherein the plurality of image statistics comprises a luminance/chrominance value.

5. The computerized apparatus of claim 1, wherein the encoder parameter comprises a quantization parameter.

6. The computerized apparatus of claim 1, wherein the storage apparatus having the non-transitory computer readable medium further comprises one or more instructions which are configured to, when executed by the processing apparatus, cause the computerized apparatus to:
compare the plurality of image statistics of the first frame of data to image statistics of a second frame of data included within the video segment, the second frame of data preceding the first frame of data.

7. The computerized apparatus of claim 6, wherein the storage apparatus having the non-transitory computer readable medium further comprises one or more instructions which are configured to, when executed by the processing apparatus, cause the computerized apparatus to:
determine a change in motion and/or a change in environment from the second frame of data to the first frame of data based upon the determined variance of the plurality of image statistics between the first frame of data and the second frame of data.

8. The computerized apparatus of claim 7, wherein the storage apparatus having the non-transitory computer readable medium further comprises one or more instructions which are configured to, when executed by the processing apparatus, cause the computerized apparatus to:
adjust a motion estimation search range based upon the determined change in motion and/or the determined change in environment.

9. The computerized apparatus of claim 7, wherein the storage apparatus having the non-transitory computer readable medium further comprises one or more instructions which are configured to, when executed by the processing apparatus, cause the computerized apparatus to:
insert intra-frame data into the first frame of video data based upon the obtained plurality of image statistics.

10. The computerized apparatus of claim 6, wherein the storage apparatus having the non-transitory computer readable medium further comprises one or more instructions which are configured to, when executed by the processing apparatus, cause the computerized apparatus to:
determine whether to perform implicit weighted prediction or explicit weighted prediction based upon the determined variance of the plurality of image statistics between the first frame of data and the second frame of data.

11. A method for the encoding of imaging data, the method comprising:
obtaining a first frame of data, the first frame of data including a plurality of frame portions;
obtaining a plurality of image statistics associated with the first frame of data, the plurality of image statistics representing imaging parameters within individual frame portions of the first frame of data;
determining variance of the plurality of image statistics for the individual frame portions of the first frame of data; and
adjusting the values of an encoder parameter within individual frame portions of the first frame of data based upon the determined variance.

12. The method of claim 11, further comprising:
comparing the plurality of image statistics of the first frame of data to image statistics of a second frame of data included within a video segment, the second frame of data preceding the first frame of data.

13. The method of claim 12, further comprising:
determining a change in motion and/or a change in environment from the second frame of data to the first frame of data based upon the determined variance of the plurality of image statistics between the first frame of data and the second frame of data; and
adjusting a motion estimation search range based upon the determined change in motion and/or the determined change in environment.

14. The method of claim 11, further comprising:
determining whether to perform implicit weighted prediction or explicit weighted prediction based upon the determined variance of the plurality of image statistics between the first frame of data and the second frame of data.

15. The method of claim 14, when it has been determined to perform explicit weighted prediction, the method further comprises:
constructing a mapping table, the mapping table configured to map possible image statistic values with explicit weighting prediction parameters.

16. The method of claim 15, further comprising:
modifying individual ones of the explicit weighting prediction parameters based at least in part on scene characteristics associated with frames contained within a video segment.

17. A computerized apparatus for the encoding of imaging data, the computerized apparatus comprising:
a network interface, the network interface configured to transmit encoded frames of video data;
a video encoder configured to receive one or more frames of video data, the video encoder also configured to provide the encoded frames of video data to the network interface; and
an encoder controller, the encoder controller configured to receive a plurality of imaging statistics from one or more modules of an image signal processing (ISP) pipeline;
wherein the encoder controller is configured to modify an encoder parameter and provide the modified encoder parameter to the video encoder, the modified encoder parameter being generated at least in part on the received plurality of imaging statistics.

18. The computerized apparatus of claim 17, wherein the computerized apparatus is further configured to determine variance within the plurality of imaging statistics.

19. The computerized apparatus of claim 17, wherein the computerized apparatus is further configured to determine a change in the received one or more frames of video data and adjust a motion estimation search range based at least in part on the determined change.

20. The computerized apparatus of claim 17, wherein the encoder controller is further configured to determine whether to use explicit or implicit weighting prediction, the determination of whether to use explicit or implicit weighting prediction being based at least in part on the received plurality of imaging statistics.
